(19) United States
(12) Patent Application Publication
(10) Pub. No.: US 2006/0032932 A1
(43) Pub. Date: Feb. 16, 2006

(54) Thermostatic outlet adapter

(76) Inventor: Trevor David Bartlett, Riverton, WY (US)

Correspondence Address: Barber Legal, PO Box 16220, Golden, CO, 80402-6004, US

(21) Appl. No.: 10/915,876

(22) Filed: Aug. 11, 2004

(51) Int. Cl. F23N 5/20; G05D 23/00

(52) U.S. Cl. 236/94; 236/46 R

(57) ABSTRACT

An electrical outlet adapter has a thermostat, a plug to allow connection to a standard electrical outlet, an outlet to accept a standard electrical plug, and a switch controlled by the thermostat to cut off or allow an operative electrical connection between the plug and outlet, allowing automatic thermostatic control of electrical appliances. In alternative embodiments, a remote control may be used. Digital readouts, clocks, timers, an over-ride switch, and large print indicia may be included.

### FIELD OF THE INVENTION

This invention relates generally to thermostats and specifically to thermostatic control of plug-in electrical appliances.

### CROSS-REFERENCE TO RELATED APPLICATIONS

N/A

### STATEMENT REGARDING FEDERALLY FUNDED RESEARCH

This invention was not made under contract with an agency of the US Government, nor by any agency of the US Government.

### BACKGROUND OF THE INVENTION

The present invention is intended to alleviate a problem shared by millions of people worldwide. During hot weather, many people rely upon “window” air conditioners, fans and evaporative coolers to keep cool, and during cool weather, electrical heaters are used to maintain warmth. In addition, a wide variety of other reasons exist why a given appliance may be desirably operated during times at which there is a certain temperature range in effect: humidifiers and similar devices are an example of this.

However, many appliances are not inherently thermostatically controlled. Thus there is a problem. In the case of an evaporate cooler (“swamp cooler”) used to cool the air during hot days, night time presents a dilemma. If the cooler is left off, the temperature may rise to an uncomfortable level. If the cooler is left off, the temperature may rise to an uncomfortable level. The only alternative would appear to be continual manual adjustments, another undesirable night time condition.

A thermostatically controlled electrical outlet would assist in maintaining a comfortable temperature range during such periods when continuous human control is undesirable or impossible: night time, periods of absence.

U.S. Pat. No. 6,619,055 issued Sep. 16, 2003 to Addy, entitled Security System with Wireless Thermostat and Method of Operation Thereof merely has a wireless thermostat of apparently dissimilar type, a built in thermostat. U.S. Pat. No. 6,394,359 issued May 28, 2002 to Morgan for a patent entitled Remote Control Thermostat also teaches an ordinary built in thermostat with a remote control.

U.S. Pat. No. 5,812,902 issued Sep. 29, 1998 Creasy et al entitled System and Process for Control of Energy Use by Direct Observation of Occupancy teaches use of a thermostat under control of sensors which might theoretically include a heat sensor.

U.S. Pat. No. 5,465,014 issued Nov. 7, 1995 to Avvisati entitled Aquarium Heater Over-ride Control System is a dissimilar area of technology: a thermostat of some type used to control a plug in appliance. Note that the thermostat in this case goes into a fish tank.

U.S. Pat. No. 5,386,461 issued Jan. 31, 1995 to Gedney entitled Telephone Operated Heating, Ventilating and/or Air Conditioning allows remote control by telephone: similar systems are used on houses, but none of these are similar to the present invention.

U.S. Pat. No. 5,361,982 issued Nov. 8, 1994 to Liebl et al entitled Temperature Control System Having Central Control for Thermostats is obviously about remote (central) control of thermostats, but it appears to operate through the house wiring.

U.S. Pat. No. 5,294,838 issued Mar. 15, 1994 to Juravich entitled Thermostatically Controlled Electrical Outlet Apparatus features an impressive amount of extra hardware projecting from the bottom-back, and lacks certain features of the present invention.

U.S. Pat. No. 4,824,013 issued Apr. 25, 1989 to Gouldey entitled Temperature Controller teaches a thermostat of relatively little interest.

U.S. Pat. No. 4,682,648 issued Jul. 28, 1987 to Fried entitled Temperature Offset Control System is another system using the house wiring to control heating systems.

U.S. Pat. No. 4,336,902 issued Jun. 29, 1982 to Neal entitled Thermostat Alterable by Remote Control mentions the possibility of over-ride in a structurally different form.

U.S. Pat. No. 4,060,123 issued Nov. 29, 1977 to Hoffman et al entitled Energy Saving Temperature Control Apparatus is an odd device in the same general area.

U.S. Pat. No. 3,486,081 issued Dec. 23, 1969 to Kanbar for Extension Thermostat and Adapter Assembly is an old patent, but of interest. It taught the use of a plug in device with male and female plugs and a thermostatic control, and an analog type dial on the front. It nonetheless lacks certain features claimed in the present invention.

It would be advantageous to provide an electrical outlet adapter having a full range of functionality to allow thermostatic control of electrical appliances.

It would be advantageous to provide an electrical outlet adapter allowing over-ride of thermostatic control of electrical appliances.

It would be advantageous to provide an electrical outlet adapter allowing remote thermostatic control of electrical appliances.

It would be advantageous to provide an electrical outlet adapter allowing convenient reading of the device via digital readouts, oversized indicia, a clock and thermometer.

### SUMMARY OF THE INVENTION

General Summary

The present invention teaches a plug-in thermostatic module, into which an electrical plug may in turn be plugged, so that an electrical appliance may be automatically thermostatically controlled.

The invention may have an over-ride switch allowing the user to activate the device when the thermostat would otherwise prevent such activation, and providing the user the ability to turn the device off when on.

A remote control embodiment allows the user to control operation of the device from a remote hand held unit having a radio, infra-red or similar wireless link to the outlet.

In embodiments, digital read outs may be provided.

In other embodiments, over-sized indicia allowing reading from a distance or reading by individuals with sight impediments may be provided.

In yet other embodiments, a convenience clock may be provided so that users may determine the time at the outlet or remote control, and in yet other embodiments, a temperature readout may be provided for the same purpose.

Summary in Reference to Claims

It is therefore a first aspect, advantage, objective and embodiment of the present invention to provide an electrical outlet adapter comprising: a case; at least one electrical socket disposed within the case, the electrical socket dimensioned and configured to accept a standard electrical plug; at least one electrical plug disposed within the case, the electrical plug dimensioned and configured to enter a standard electrical outlet; a thermostat disposed at least partially within the case, the thermostat controlling a switch having a first position in which an operative electrical connection is made between the electrical plug and the electrical socket, and further having a second position in which the electrical plug and electrical socket are isolated from one another.

It is therefore a first aspect, advantage, objective and embodiment of the present invention to provide an electrical outlet adapter further comprising: an analog temperature input device allowing input to the thermostat of any of a range of temperatures at which the thermostat alters the position of the switch.

It is therefore a first aspect, advantage, objective and embodiment of the present invention to provide an electrical outlet adapter further comprising: a digital display of ambient temperature, a digital display of temperature at which the thermostat alters the position of the switch from the first position to the second position, a digital temperature input device allowing input to the thermostat of any of a range of temperatures at which the thermostat alters the position of the switch.

It is therefore a first aspect, advantage, objective and embodiment of the present invention to provide an electrical outlet adapter further comprising: a digital display of temperature at which the thermostat alters the position of the switch from the second position to the first position, further comprising: a backlight.

It is therefore a first aspect, advantage, objective and embodiment of the present invention to provide an electrical outlet adapter further comprising: a clock having an easily visible time display.

It is therefore a first aspect, advantage, objective and embodiment of the present invention to provide an electrical outlet adapter further comprising: a timer circuit controlling the switch.

It is therefore a first aspect, advantage, objective and embodiment of the present invention to provide an electrical outlet adapter further comprising: a user over-ride input controlling the switch to over-ride the thermostatic control of the switch user and alter the position of the switch upon manual activation.

It is therefore a first aspect, advantage, objective and embodiment of the present invention to provide an electrical outlet adapter further comprising: a display indicating that the over-ride is activated.

It is therefore a first aspect, advantage, objective and embodiment of the present invention to provide an electrical outlet adapter further comprising: large indicia having a size permitting reading of the indicia by individuals standing at a distance from the adapter.

It is therefore a first aspect, advantage, objective and embodiment of the present invention to provide an electrical outlet adapter further comprising: a night light.

It is therefore a first aspect, advantage, objective and embodiment of the present invention to provide an electrical outlet adapter comprising: at least one electrical socket disposed within the case, the electrical socket dimensioned and configured to accept a standard electrical plug; at least one electrical plug disposed within the case, the electrical plug dimensioned and configured to enter a standard electrical outlet; a signal receiver unit in operative communication with a remote control unit; the remote control unit comprising a case; a thermostat disposed at least partially within the case; a transmitter unit in operative communication with the signal receiver unit; the thermostat controlling via the transmitter and receiver a switch having a first position in which an operative electrical connection is made between the electrical plug and the electrical socket, and further having a second position in which the electrical plug and electrical socket are isolated from one another.

It is therefore a first aspect, advantage, objective and embodiment of the present invention to provide an electrical outlet adapter wherein the remote control unit further comprises: a digital display of ambient temperature, a digital display of temperature at which the thermostat alters the position of the switch from the first position to the second position, a digital temperature input device allowing input to the thermostat of any of a range of temperatures at which the thermostat alters the position of the switch.

It is therefore a first aspect, advantage, objective and embodiment of the present invention to provide an electrical outlet adapter wherein the remote control unit further comprises: a digital display of temperature at which the thermostat alters the position of the switch from the second position to the first position, wherein the remote control unit further comprise: a clock having an easily visible time display.

It is therefore a first aspect, advantage, objective and embodiment of the present invention to provide an electrical outlet adapter wherein the remote control unit further comprises: a timer circuit controlling the switch.

It is therefore a first aspect, advantage, objective and embodiment of the present invention to provide an electrical outlet adapter wherein the remote control unit further comprises: a user over-ride input controlling the switch to over-ride the thermostatic control of the switch user and alter the position of the switch upon manual activation.

It is therefore a first aspect, advantage, objective and embodiment of the present invention to provide an electrical outlet adapter wherein the remote control unit further comprises: a display indicating that the over-ride is activated.

It is therefore a first aspect, advantage, objective and embodiment of the present invention to provide an electrical outlet adapter further comprising: large indicia having a size permitting reading of the indicia by individuals standing at a distance from the adapter.

### BRIEF DESCRIPTION OF THE DRAWINGS

FIG. 1 is a perspective front elevational view of a first analog embodiment of the invention.

FIG. 2 is a perspective rear elevational view of the first embodiment of the invention.

FIG. 3 is a perspective front elevational view of a second digital embodiment of the invention.

FIG. 4 is a front elevational perspective view of a third, remotely controlled embodiment of the invention.

FIG. 5 is a rear elevational perspective view of the third remotely controlled embodiment of the invention.

FIG. 6 is a front elevational perspective view of the remote control unit of the third embodiment of the invention.

FIG. 7 is a rear elevational perspective view of the remote control unit of the third embodiment of the invention.

FIG. 8 is a flow-chart of operations of the third embodiment's remote control unit.

FIG. 9 is a flow-chart of operations of the third embodiment's outlet unit.

### INDEX TO REFERENCE NUMERALS

Case 10
Case rear 11
Case front 12
Thermostat/switch 13
Electrical outlet 14
Analog “off” temperature device 16
Analog “on” temperature device 18
Indicia 20
Electrical plug 22
Case 110
Outlet 114
Digital “on” display 124
Digital “off” display 126
Digital ambient temperature display 128
LED display 130
Mode set button 132
Value adjustment buttons 134
Case 210
Case rear 211
Case front 212
First electrical outlet 214
Second electrical outlet 214a
First electrical plug 222
Second electrical plug 222a
Manual over-ride 236
Indicators 238
Case 310
Case rear 311
Case front 312
Digital “on” display 324
Digital “off” display 326
Over-ride 336
Program control 340
Clock display 342
Thermometer display 344
Over-sized indicia 346
Swing out stand 348
Battery cover 350
Mounting 352
First battery check 1002
Second battery check 1004
Display battery low 1006
Measure ambient temperature 1008
Display ambient temperature 1010
Retrieve/store/display temperature
   “on”/“off” settings 1012
Check manual over-ride 1014
Send “on” signal 1016
Display “over-ride on” 1018
Display “over-ride off” 1020
Check ambient versus “on” 1022
Retrieve on/off status 1024
Check on/off status 1026
Send “on” signal 1028
Store “on” status 1030
Check ambient versus “off” 1032
Retrieve on/off status 1034
Check on/off status 1036
Send “off” signal 1038
Store “off” status 1040
Check over-ride status 1102
Energize outlet 1104
Stand by 1106
Receive signal 1108
Check for “on” signal 1110
Check outlet on/off status 1112
Energize outlet 1114
Check for “off” signal 1116
Check outlet on/off status 1118
Switch outlet off 1120

### DETAILED DESCRIPTION

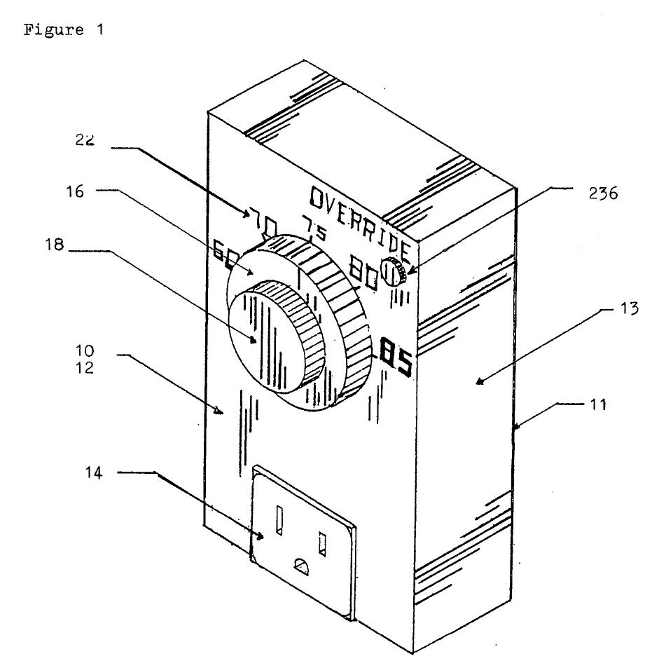

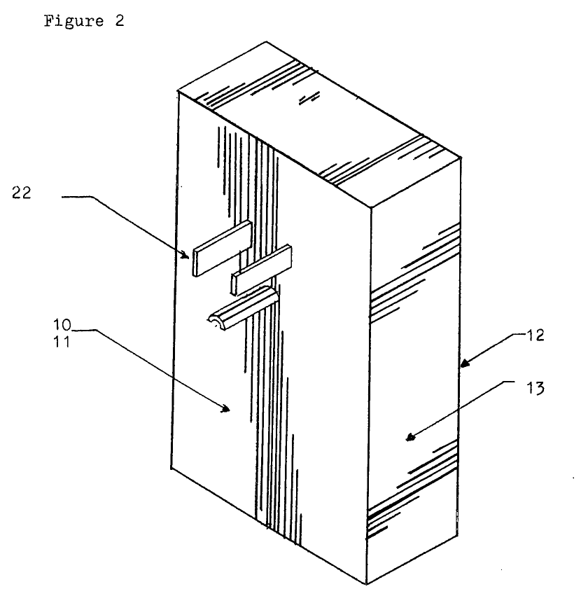

FIG. 1 is a perspective front elevational view of a first analog embodiment of the invention. FIG. 2 is a perspective rear elevational view of the first embodiment of the invention. Case 10 has case rear 11 and case front 12. Electrical outlet 14 projects from case front 12 in the preferred embodiments, but it may be under a cover, on a side, top or bottom in other embodiments. Analog “off” temperature device 16 and analog “on” temperature device 18 are dials in the first embodiment but may be other analog or mechanical devices. Indicia 20 show temperature in the first embodiment, but in other embodiments discussed below may indicate other quantities and may be larger. Electrical plug 22 is in the best modes now contemplated located on case rear 11, but may be on other face/faces of the case. The electrical socket is dimensioned and configured to accept a standard electrical plug, and the electrical plug is dimensioned and configured to enter a standard electrical outlet. A thermostatic switch 13 disposed at least partially within the case controls a switch part having a first position in which an operative electrical connection is made between the electrical plug and the electrical socket; the switch part also has a second position in which the electrical plug and electrical socket are isolated from one another. Thus automatic thermostatic control of an appliance plugged into the device may be assured. The thermostat and switch may be pictured (as in FIG. 1) as one device, or may be considered two devices.

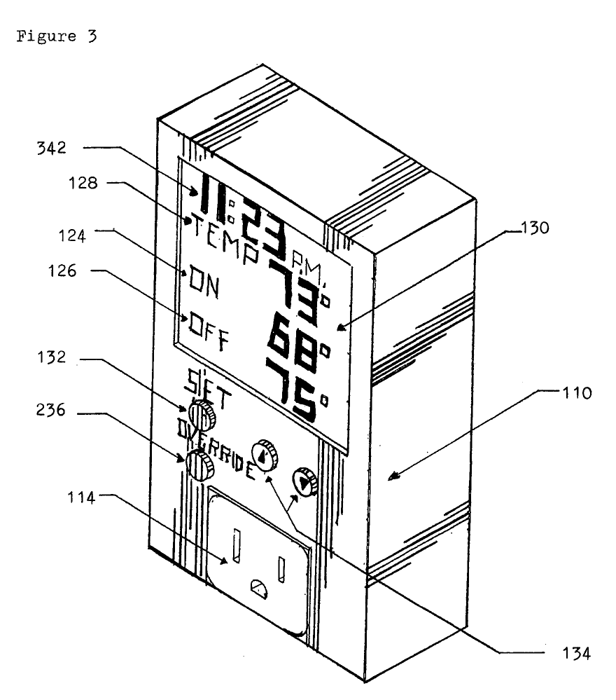

FIG. 3 is a perspective front elevational view of a second digital embodiment of the invention. Case 110 and outlet 114 are much as in the mechanical/analog embodiment. Digital “on” display 124 and digital “off” display 126 show the temperatures at which the device respectively turns on or off. Note that a single temperature control may be used in other embodiments, but in the presently preferred embodiments, two temperatures are used.

Digital ambient temperature display 128 shows the output of a thermometer or the thermostat—the thermostat may of course be considered to be a thermometer with additional switch structures.

LED display 130 is shown as a single display having several output functions, but of course a group of LED displays may be used, or a single LED panel may be used to display more than one item of information, for example, in response to user queries or in a timed sequence. The display may have a backlight, thus obviating the problem of waking up at night, when the use of the device is highly desirable, and needing to turn on a light in order to determine the present conditions. The backlight may function as a night light as well, or separate night lights may be incorporated.

Mode set button 132 and value adjustment buttons 134 allow a user to select the function they desire to change and then alter it. For example, pushing mode set button 132 one time might enable changing the “off” temperature, then pressing the up or down indicated buttons might alter the displayed “off” temperature one degree (or another increment) as desired.

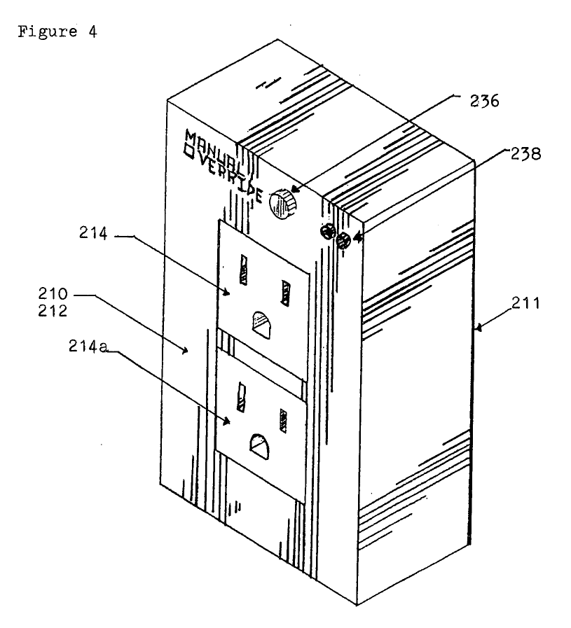

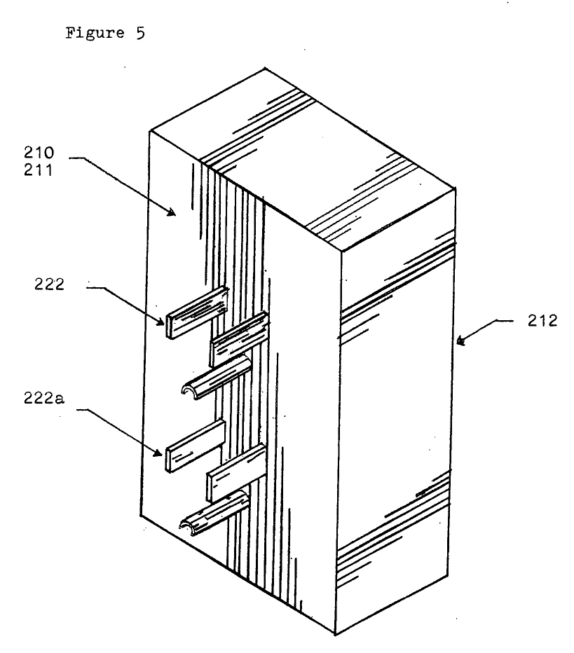

FIG. 4 is a front elevational perspective view of a third, remotely controlled embodiment of the invention. FIG. 5 is a rear elevational perspective view of the third remotely controlled embodiment of the invention. Case 210 is relatively plain, as in this embodiment of the remotely controlled embodiment, displays and control functions are moved to the remote unit discussed later. However, in alternative embodiments, the case 210 may have the displays instead of the remote unit, or both the wall unit and the remote unit may have displays and controls, etc.

Case rear 211 and case front 212 have respectively first electrical outlet 214 and second electrical outlet 214a, and first electrical plug 222 and second electrical plug 222a. In this embodiment, the device will cover the typical two socket outlet but allow use of two devices at once under the automatic thermostatic control. In other embodiments, a single plug may be connected to two outlets of the device and so on.

The benefits of control of two devices are numerous. For example, a light might be added to the circuit both the alert the owner when the controlled device (evaporative cooler, fan, etc) is on, or to provide a highly variable and random light on/off appearance to a home, thus deterring crime.

Manual over-ride 236 is a unique feature of the invention which allows a user to alter the on/off status of the controlled device without actually changing the normal temperature settings thereof. Pushing manual over-ride 236 in this embodiment will energize the outlet when the on/off status is presently off, but in other embodiments the function may be reversed, or there may be two functions: turn the device off when temperature based on/off status is on, and turn the device on when the status is off.

Indicators 238 may be lights, LEDs, etc, allowing simple indication of more simple status queries such as on/off status or the like. Indicators 238 may also function as night lights, independent of any back light.

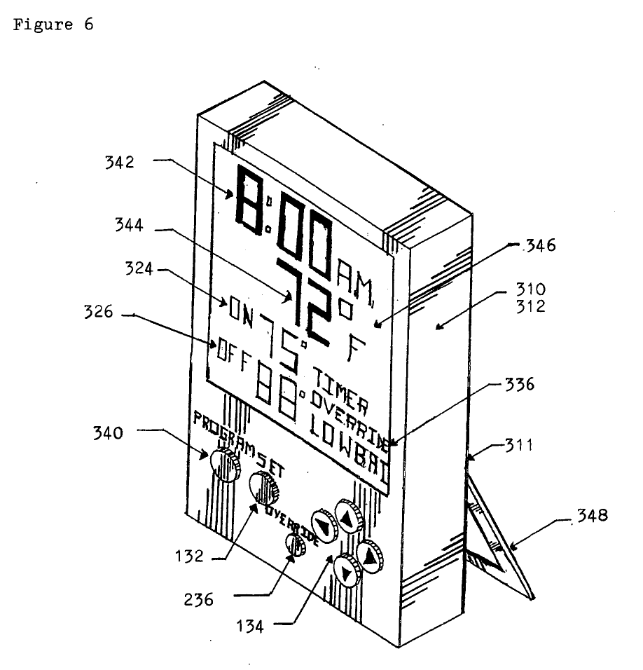

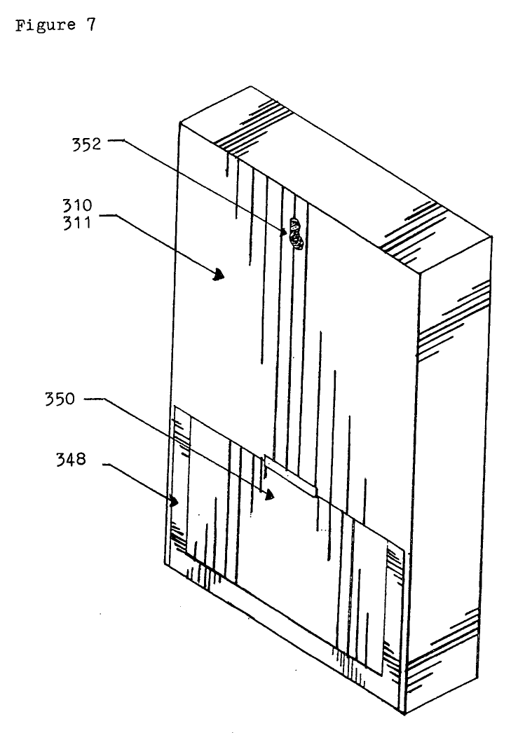

FIG. 6 is a front elevational perspective view of the remote control unit of the third embodiment of the invention and FIG. 7 is a rear elevational perspective view of the remote control unit of the third embodiment of the invention. Case 310 has case rear 311 and case front 312 bearing digital “on” display 324, digital “off” display 326, over-ride 336 and other controls and displays.

Program control 340 allows programming of the device's electronic functions. Clock display 342 shows present time, while thermometer display 344 may display ambient temperature. In this embodiment as in most, the thermostat is entirely within the case.

Over-sized indicia 346 are important to the invention. Prior art devices required the users to get close to the control unit or base unit in order to merely read the indicia and determine the present situation or whether alterations were called for. The present invention, however, allows a user far from the remote control to determine whether action is required, and in embodiments not having a remote control but having over-sized indicia on the base unit, the same principle holds true for the base unit.

Swing out stand 348 allows the remote control to be easily set up as a desktop/countertop/vanity clock/thermometer, and thus aids location, reading, grasping and other use of the device. Swinging the stand 348 back in allows easy holding of the device and allows laying it down flat in a more usual remote control configuration.

Battery cover 350 may be removed to reveal batteries powering the remote control unit.

Mounting 352 may as in the presently preferred embodiment be a small hole allowing easy wall mounting to a nail, brad, tack or the like. However, other mounting may be used: adhesive, hook and loop fabric, hooks, eyelets, magnets and the like.

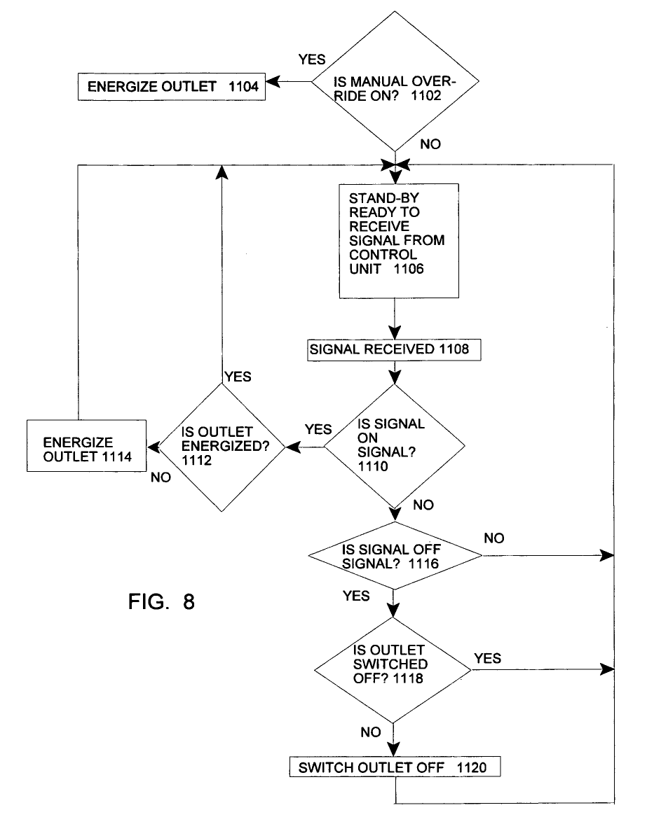

FIG. 8 is a flowchart of operations of the third embodiment's remote control unit.

First battery check 1002 of status leads to second battery check 1004 decision: if the batter is low, then the device will display battery low 1006 indicators. Next, the device will measure ambient temperature 1008 and display ambient temperature 1010. Then the device will retrieve/store/display temperature “on”/“off” settings 1012 and begin to check conditions for altering the condition of the controlled appliance. Check manual over-ride step 1014 leads to send “on” signal 1016 if answered in the affirmative, indicating that the user desires an over-ride. The unit then displays “over-ride on” 1018 as a visual reminder to the user. Display of the “over-ride off” indicator 1020 occurs in the alternative case, though in alternative embodiments this step may not be necessary.

Check of ambient temperature versus “on” temperature at step 1022 may indicate that the “on” temperature has been reached, thus necessitating the following steps: retrieval of on/off status 1024 and check of that on/off status (step 1026), and if the status is “off”, then sending of the “on” signal 1028 from the remote control unit to the base unit is necessary. Finally, the unit stores “on” status 1030.

However, if the “on” temperature check is negative, then the remote unit will check ambient temperature versus the “off” temperature at step 1032. If the result is negative, operations return to step 1002

However, a positive response causes the unit to retrieve on/off status 1034 and check on/off status (step 1036), and if the status is “on”, then it sends “off” signal 1038 to the base/wall unit and finally store “off” status 1040 before returning to step 1002.

While the threshold on/off value comparisons may be logical “equals”, they may also be “equal to or less than”, “equal to or greater than”, “less than”, “greater than” comparisons as well.

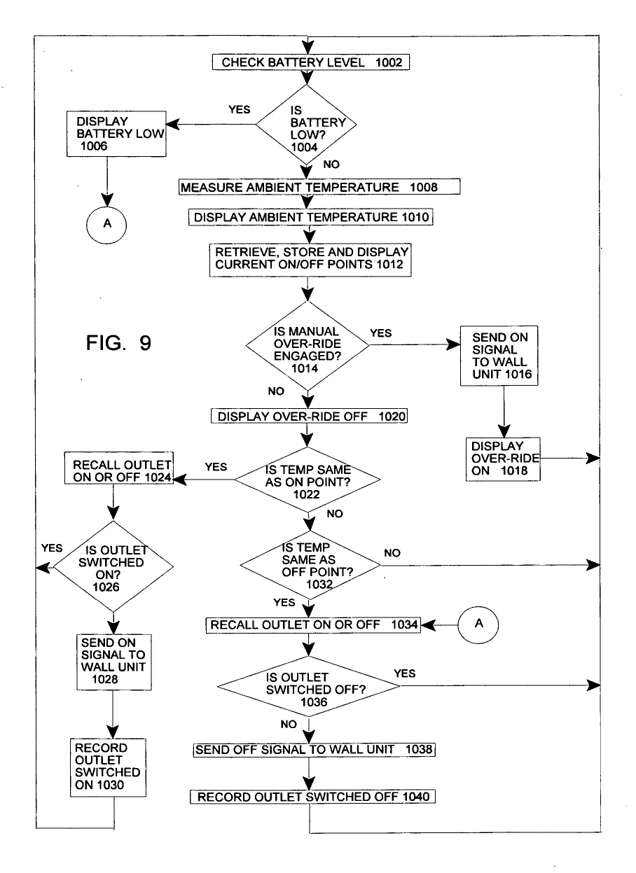

FIG. 9 is a flow-chart of operations of the third embodiment's wall outlet unit. Check over-ride status 1102 is (if the over-ride has been activated) followed by energize outlet 1104, or in the alternative by stand by 1106, in which the unit awaits instructions from the remote unit. When a receive signal condition 1108 occurs, the device will check for an “on” signal 1110 and if it has been received, it will check outlet on/off status 1112 and then if the outlet was previously unenergized, it will energize the outlet at step 1114. If there is not an “on” signal received, the unit will check for an “off” signal 1116 instead and if it was received, will check outlet on/off status 1118 and if the outlet is “on” will switch the outlet off at step 1120.

The steps of these procedures/methods may be altered in order and type without departing from the essential scope of the invention.

In the presently preferred embodiment and best mode presently contemplated for carrying out the invention, the controls are done at the remote unit and the base unit is little more than a receiver and switch. In alternative embodiments, controls or displays may be carried out at the base unit and the remote unit is little more than a control and transmission device.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. An electrical outlet adapter comprising:
a case;
at least one electrical socket disposed within the case, the electrical socket dimensioned and configured to accept a standard electrical plug;
at least one electrical plug disposed within the case, the electrical plug dimensioned and configured to enter a standard electrical outlet;
a thermostat disposed at least partially within the case, the thermostat controlling a switch having a first position in which an operative electrical connection is made between the electrical plug and the electrical socket, and further having a second position in which the electrical plug and electrical socket are isolated from one another.

2. The electrical outlet adapter of claim 1, further comprising:
an analog temperature input device allowing input to the thermostat of any of a range of temperatures at which the thermostat alters the position of the switch.

3. The electrical outlet adapter of claim 1, further comprising:
a digital display of ambient temperature,
a digital display of temperature at which the thermostat alters the position of the switch from the first position to the second position,
a digital temperature input device allowing input to the thermostat of any of a range of temperatures at which the thermostat alters the position of the switch.

4. The electrical outlet adapter of claim 3, further comprising:
a digital display of temperature at which the thermostat alters the position of the switch from the second position to the first position.

5. The electrical outlet adapter of claim 1, further comprising:
a backlight.

6. The electrical outlet adapter of claim 1, further comprising:
a clock having an easily visible time display.

7. The electrical outlet adapter of claim 1, further comprising:
a timer circuit controlling the switch.

8. The electrical outlet adapter of claim 1, further comprising:
a user over-ride input controlling the switch to over-ride the thermostatic control of the switch user and alter the position of the switch upon manual activation.

9. The electrical outlet adapter of claim 8, further comprising:
a display indicating that the over-ride is activated.

10. The electrical outlet adapter of claim 1, further comprising:
large indicia having a size permitting reading of the indicia by individuals standing at a distance from the adapter.

11. The electrical outlet adapter of claim 1, further comprising:
a night light.

12. An electrical outlet adapter comprising:
at least one electrical socket disposed within the case, the electrical socket dimensioned and configured to accept a standard electrical plug;
at least one electrical plug disposed within the case, the electrical plug dimensioned and configured to enter a standard electrical outlet;
a signal receiver unit in operative communication with a remote control unit;
the remote control unit comprising a case;
a thermostat disposed at least partially within the case;
a transmitter unit in operative communication with the signal receiver unit; the thermostat controlling via the transmitter and receiver a switch having a first position in which an operative electrical connection is made between the electrical plug and the electrical socket, and further having a second position in which the electrical plug and electrical socket are isolated from one another.

13. The electrical outlet adapter of claim 11, wherein the remote control unit further comprises:
a digital display of ambient temperature,
a digital display of temperature at which the thermostat alters the position of the switch from the first position to the second position,
a digital temperature input device allowing input to the thermostat of any of a range of temperatures at which the thermostat alters the position of the switch.

14. The electrical outlet adapter of claim 13, wherein the remote control unit further comprises:
a digital display of temperature at which the thermostat alters the position of the switch from the second position to the first position.

15. The electrical outlet adapter of claim 12, wherein the remote control unit further comprise:
a clock having an easily visible time display.

16. The electrical outlet adapter of claim 12, wherein the remote control unit further comprises:
a timer circuit controlling the switch.

17. The electrical outlet adapter of claim 12, wherein the remote control unit further comprises:
a user over-ride input controlling the switch to over-ride the thermostatic control of the switch user and alter the position of the switch upon manual activation.

18. The electrical outlet adapter of claim 17, wherein the remote control unit further comprises:
a display indicating that the over-ride is activated.

19. The electrical outlet adapter of claim 12, further comprising:
large indicia having a size permitting reading of the indicia by individuals standing at a distance from the adapter.
